(19) United States
(12) Patent Application Publication
(10) Pub. No.: US 2017/0016845 A1
(43) Pub. Date: Jan. 19, 2017

(54) TEST STRIP

(71) Applicant: TYSON BIORESEARCH INC., Miaoli County (TW)

(72) Inventors: Cheng-Che Lee, Hsinchu County (TW); Han-Ching Tsai, New Taipei City (TW); Cheng-Yun Hsiao, Tainan City (TW); Jen-Hao Liu, Taipei City (TW)

(21) Appl. No.: 15/201,605

(22) Filed: Jul. 4, 2016

(30) Foreign Application Priority Data
Jul. 17, 2015 (TW) 104123195

(51) Int. Cl. G01N 27/327; B01L 3/00

(52) U.S. Cl. CPC G01N 27/3272; B01L 3/502715; B01L 3/502723; B01L 2300/0887; B01L 2300/165; B01L 2200/0684; B01L 2300/161; B01L 2300/168; B01L 2300/0645; B01L 2200/16

(57) ABSTRACT

A test strip includes a substrate, a spacer layer having a notch, a reagent layer, a support layer, and a cover layer having a covering portion covering the notch and a channel portion extending rearward from the covering portion corresponding to a rear end of the notch. The substrate is attached under the spacer layer and has a reaction region exposed from the notch. The support layer is located at two sides of the notch and connected to the cover layer and the spacer layer to make the channel portion away from the spacer layer at a vertical distance. The support layer, the covering portion, the notch, and the substrate form a reaction chamber for allowing an analyte solution to react with the reagent layer coated on the reaction region, and the support layer, the channel portion, and the spacer layer forms a channel for exhausting air.

### BACKGROUND OF THE INVENTION

1. Field of the Invention

The present invention relates to a test strip, and more specifically, to a test strip utilizing a channel formed cooperatively by a spacer layer, a channel portion of a cover layer, and a support layer to exhaust air staying in a reaction chamber.

2. Description of the Prior Art

In general, test strips for detecting analyte solutions are usually divided into two types: a colorimetric chemical/biochemical test strip without electrodes and an electrical sensing strip composed of a chemical/biochemical/electrochemical identifying component by electrical signals transformation. The electrical sensing strip could transform chemical signals into electrical signals (i.e. electrochemical reactions) via the electrical signal transformer after the analyte solution is identified by the chemical/biochemical/electrochemical identifying component, and then could calculate the concentration of the analyte solution according to the electrical signals. A conventional electrical sensing strip usually utilizes an amperometric biosensor to get a reaction current of an analyte solution by controlling electric potentials of a working electrode and an auxiliary electrode. The electrical sensing strip has been applied to detection of blood glucose, cholesterol or other medicines. A conventional design is to sequentially stack an electrode layer, a spacer layer having a notch, a biocatalyst reagent layer, and a cover layer on a substrate to form a reaction chamber having an opening for an analyte solution. Accordingly, a micro channel could be formed so as to absorb the analyte solution into the reaction chamber via the capillary phenomenon for making the analyte solution react with the biocatalyst reagent layer. In this design, when the analyte solution enters the reaction chamber, air originally in the reaction chamber space cannot be exhausted if the opening side of the reaction chamber is filled with the analyte solution to form an airtight space. Accordingly, the analyte solution would stop flowing inwardly when there is a balance between an internal air pressure of the reaction chamber and an inward pressure formed by a cohesive force and an adhesion force of the analyte solution, so as to influence the detecting accuracy of the electrical sensing strip.

For solving the aforesaid problem, an upward (or downward) exhausting design that a hole (or a slit) is formed on the cover layer or the substrate is applied to the electrical sensing strip for ensuring that the air originally in the reaction chamber space could be exhausted smoothly. However, the aforesaid design needs the hole to be positioned precisely at the middle of a rear end of the reaction chamber for exhausting the air, such that this structure design causes a time-consuming and strenuous adhesive process for the cover layer. Furthermore, since the hole is just located on the upper side or lower side of the reaction chamber space which can be directly communicated with the reaction chamber in the aforesaid design, dust (or air outside the reaction chamber or moisture on a user's fingers) enters the reaction chamber via the hole easily which may influence the electrical sensing strip's detection results. Moreover, since there is no flow stopping design applied to the analyte solution in the reaction chamber, excessive amount of the analyte solution flowing over the hole not only causes the contamination problem but also causes the user to have a bad visible impression. Furthermore, since the reaction chamber communicates with the outside space directly via the hole, which may make the reaction chamber space unable to have a fixed volume and may cause a dynamic turbulence flow. Such structure may influence the detecting accuracy of the electrical sensing strip.

In practical application, some electrical sensing strips adopt the design that the cover layer is made of transparent material instead, such as the window designs mentioned in U.S. Pat. No. 6,541,216 and U.S. Pat. No. 8,409,412. However, the aforesaid transparent cover layer could make the user have a bad visible impression since the user could directly see the color of the analyte solution (e.g. blood or urine) in the reaction chamber. Furthermore, the dried biocatalyst reagent layer in the reaction chamber is an active material, so that the biocatalyst reagent layer could react with the analyte solution to generate a corresponding detection result after the analyte solution enters the reaction chamber. However, since the biocatalyst reagent layer has high activity, the detection result could be influenced easily if the biocatalyst reagent layer is excited by external energy (e.g. light) and has been reacted by the external energy before performing a test. Taking the electrical sensing strip for example, since the area nearby the electrodes is the main part to participate in the reaction, the importance to protect the activity of the biocatalyst reagent layer nearby the electrodes is more important than other parts. As light is a kind of energy, the biocatalyst reagent layer can be excited by external light. Such light energy, especially short wavelength lights (e.g. ultraviolet light), may cause the reagent inactivation when the biocatalyst reagent layer nearby the electrodes is exposed to the light through the transparent cover layer.

For solving the aforesaid reagent inactivation problem, the electrical sensing strip could adopt the design that the cover layer is made of opaque material to block the external light from being incident into the biocatalyst reagent layer. However, in the aforesaid design, whether the analyte solution entering the reaction chamber is sufficient, whether the analyte solution completely fills the reaction chamber, and whether the electrical sensing strip has been used are invisible to the naked eyes. Thus, the electrical sensing strip needs to utilize an additional electrical sensing circuit for detecting the aforesaid conditions, such that this design may prolong the detecting process and the aforesaid additional electrical sensing circuit also increases the complexity and the power consumption of the electrical sensing strip.

### SUMMARY OF THE INVENTION

The present invention provides a test strip including a spacer layer, a substrate, a reagent layer, a cover layer, and a support layer. The spacer layer has a notch. The substrate is attached under the spacer layer. The substrate has a reaction region exposed from the notch. The reagent layer is coated on the reaction region. The cover layer has a covering portion and a channel portion. The covering portion covers the notch. The channel portion extends rearward from the covering portion corresponding to a rear end of the notch. The support layer is attached on the spacer layer and is located at two sides of the notch. The support layer is connected to the cover layer and the spacer layer to make the channel portion away from the spacer layer at a vertical distance for forming a channel cooperatively with the channel portion and the spacer layer. Air originally staying in the reaction chamber can be exhausted through the channel. At least one portion on a surface of at least one of the channel portion and the spacer layer corresponding to the channel has hydrophobicity. An analyte solution can be immobilized through the hydrophobicity of the least one portion on the surface of the at least one of the channel portion and the spacer layer corresponding to the channel. Furthermore, the support layer is further used for forming a reaction chamber cooperatively with the covering portion, the notch, and the substrate. The reaction chamber allows the analyte solution to enter and then react with the reagent layer.

The present invention further provides a test strip including a spacer layer, a substrate, a reagent layer, an electrode layer, and a cover layer. The spacer layer has a notch. The substrate is attached under the spacer layer. The substrate has a reaction region exposed from the notch. The spacer layer, the substrate, and the cover layer are made of insulation material. The reagent layer is coated on the reaction region. The electrode layer is disposed between the substrate and the spacer layer. The electrode layer contacts the reagent layer for detecting an electric reaction of the analyte solution reacting with the reagent layer. The electrode layer includes at least one working electrode and an auxiliary electrode. The working electrode is used for detecting a current electrical response generated by the analyte solution reacting with the reagent layer. The auxiliary electrode is used for receiving a floating voltage to satisfy a voltage generated by the working electrode when the analyte solution reacts with the reagent layer. The cover layer has at least one transparent window formed thereon and covers the notch for forming a reaction chamber cooperatively with the notch and the substrate. The reaction chamber allows the analyte solution to enter and then react with the reagent layer. The at least one transparent window is formed on the covering layer not corresponding to the working electrode, or the at least one transparent window extends rearward from a front end of the cover layer corresponding to an opening side of the reaction chamber to cross the working electrode and has a covering pattern to partially cover the working electrode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a test strip according to an embodiment of the present invention.

FIG. 2 is an exploded diagram of the test strip in FIG. 1.

FIG. 3 is a sectional diagram of the test strip in FIG. 1 along a sectional line A-A.

FIG. 4 is a diagram of a channel portion having a hydrophobic layer partially coated thereon according to another embodiment of the present invention.

FIG. 5 is a diagram of a channel portion having a hydrophobic layer partially coated thereon according to another embodiment of the present invention.

FIG. 6 is a diagram of a channel portion having a hydrophobic layer partially coated thereon according to another embodiment of the present invention.

FIG. 7 is a partial top view of the test strip in FIG. 1.

FIG. 8 is a partial top view of a test strip according to another embodiment of the present invention.

### DETAILED DESCRIPTION

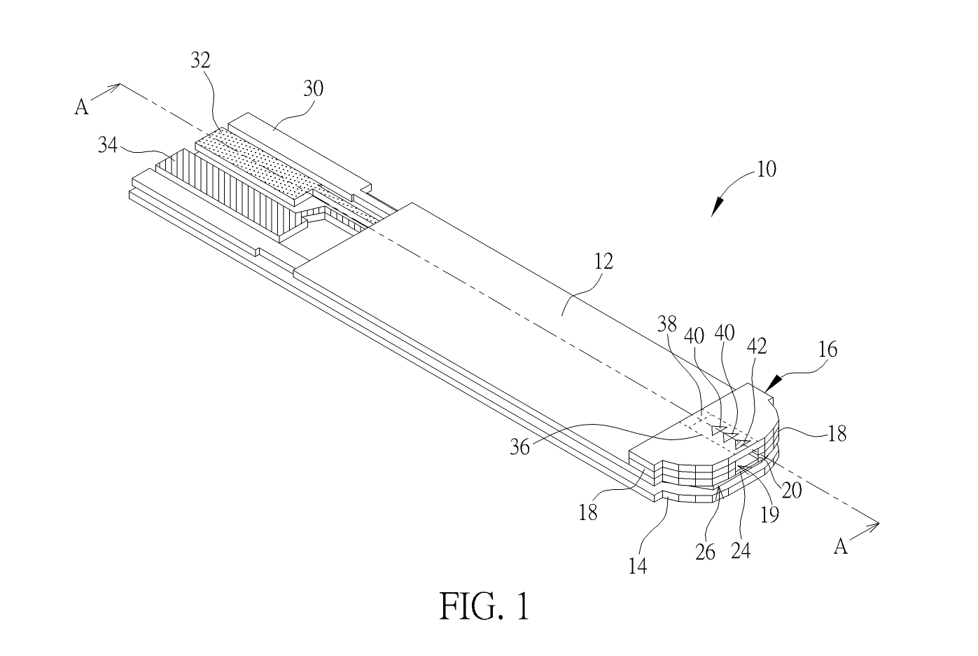

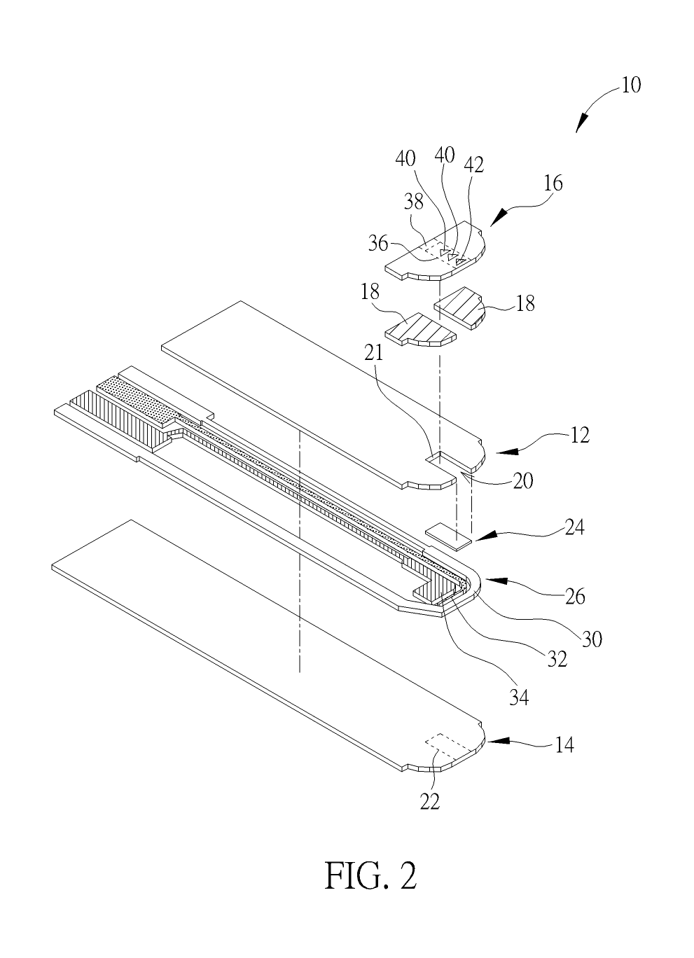

Please refer to FIG. 1 and FIG. 2. FIG. 1 is a diagram of a test strip 10 according to an embodiment of the present invention. FIG. 2 is an exploded diagram of the test strip 10 in FIG. 1. The test strip 10 could be applied to test of blood glucose, cholesterol, physiological conditions or other medicines. As shown in FIG. 1 and FIG. 2, the test strip 10 includes a spacer layer 12, a substrate 14, a cover layer 16, a support layer 18, a reagent layer 24, and an electrode layer 26. The spacer layer 12 has a notch 20. The spacer layer 12 and the cover layer 16 could be preferably made of plastic material (e.g. polyethylene terephthalate (PET) or polyethylene naphthalate (PEN)). The substrate 14 could be made of insulation material (e.g. polyethylene terephthalate). The spacer layer 12 is attached on the substrate 14 and has a reaction region 22 exposed from the notch 20, meaning that the reaction region 22 is defined by the notch 20. The reagent layer 24 is coated on the reaction region 22 by a conventional coating process, such as a drop casting process or a screen printing process. The electrode layer 26 is disposed between the substrate 14 and the spacer layer 12 and contacts the reagent layer 24 for detecting an electrical reaction of an analyte solution, such as detecting a concentration of the analyte solution. The reagent composition (e.g. biocatalyst (e.g. glucose oxidase or glucose dehydrogenase), the electron transfer mediator, the stabilizer and the adhesive) in the reagent layer 24 could vary with the type of an analyte solution to be tested. In this embodiment, the reagent layer 24 could be used for detecting concentration of glucose in blood (i.e. the analyte solution). Accordingly, when the analyte solution reacts with the reagent layer 24, the reagent layer 24 could be dissolved and then the electron could be transferred to the electrode layer 26 to produce an electrical reaction for generating a corresponding detection result.

In this embodiment, as shown in FIG. 2, the electrode layer 26 includes at least one working electrode 30 (one shown in FIG. 2, but not limited thereto), a reference electrode 32, and an auxiliary electrode 34 (but not limited thereto, meaning that the electrode layer 26 could adopt the design that the reference electrode 32 is omitted). The working electrode 30, the reference electrode 32, and the auxiliary electrode 34 could be formed on the substrate 14 by laser or could be printed on the substrate 14 by a screen printing process for forming the electrode layer 26. The working electrode 30 could be used for detecting a current electrical response generated by an analyte solution reacting with the reagent layer 24 to detect a concentration of an analyte solution. The reference electrode 32 is used for receiving a reference voltage when the analyte solution reacts with the reagent layer 24. The auxiliary electrode 34 is used for receiving a floating voltage to satisfy a voltage generated by the working electrode 30 when the analyte solution reacts with the reagent layer 24. Accordingly, the test strip 10 could detect an initial concentration of the analyte solution according to the current electrical response detected by the working electrode 30. As for the detailed description for the electrode design and the derived embodiments (e.g. the electrode layer 26 could only have the working electrode 30 and the auxiliary electrode 34 formed thereon) of the electrode layer 26, it is commonly seen in the prior art and omitted herein.

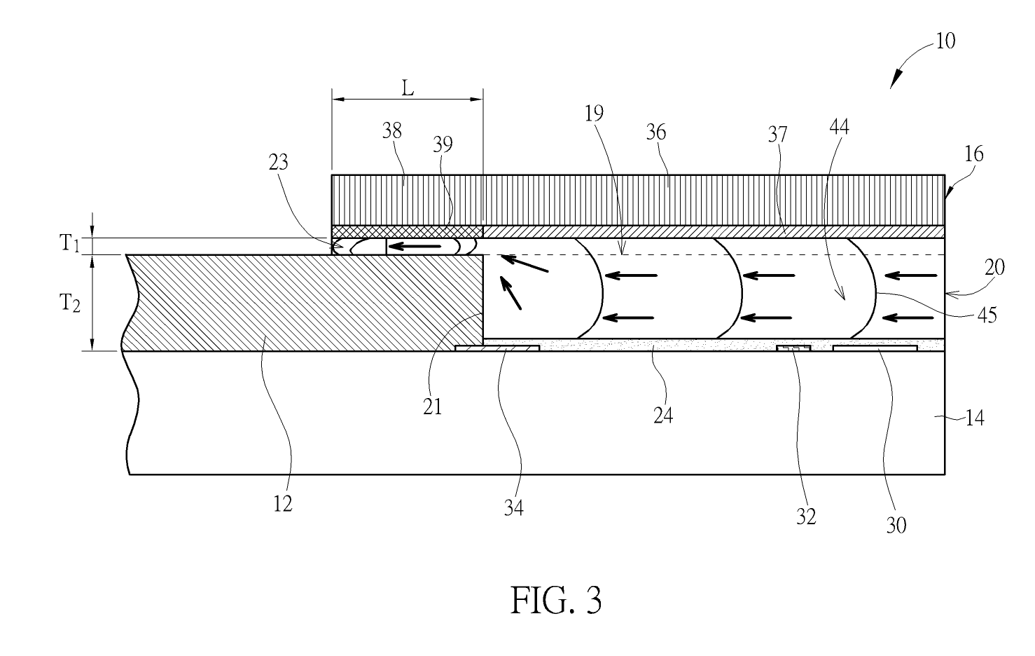

Furthermore, please refer to FIG. 3, which is a sectional diagram of the test strip 10 in FIG. 1 along a sectional line A-A. As shown in FIG. 1, FIG. 2, and FIG. 3, the cover layer 16 has a covering portion 36 and a channel portion 38. The covering portion 36 covers the notch 20, and the channel portion 38 extends rearward from the covering portion 36 corresponding to a rear end of the notch 20. The support layer 18 could be made of plastic material (e.g. polyethylene terephthalate or polyethylene naphthalate) mixed with adhesive material (e.g. polymer of vinylacetate and acrylic ester), or be only made of adhesive material. The support layer 18 is located at two sides of the notch 20 to stick the cover layer 16 on the spacer layer 12, so as to make the channel portion 38 away from the spacer layer 12 at a vertical distance T₁. Accordingly, the support layer 18 could form a reaction chamber 19 cooperatively with the covering portion 36, the notch 20, and the substrate 14, which allows an analyte solution to enter and then to react with the reagent layer 24. To be more specific, a height of the reaction chamber 19 is equal to a sum of a thickness of the support layer 18 and a thickness of the spacer layer 12, a width of the reaction chamber 19 is equal to a width of the notch 20, and a depth of the reaction chamber 19 is equal to a depth of the notch 20. The support layer 18, the channel portion 38, and the spacer layer 12 could form a channel 23, an exhaust direction of which is substantially parallel to a travelling direction of the analyte solution, for exhausting air in the reaction chamber 19. The vertical distance T₁ (i.e. the thickness of the support layer 18) could be preferably between 10 μm and 50 μm, but not limited thereto. A thickness T₂ of the spacer layer 12 could be preferably between 50 μm and 200 μm, but not limited thereto. A length L of the channel portion 38 could be preferably greater than 200 μm, but not limited thereto. In such a manner, via the structural design of the reaction chamber 19 and the structural design of the channel 23, reaction of the reagent layer 24 with the analyte solution could not be easily influenced by flowing of the analyte solution above the bottom of the reaction chamber 19 since the reagent layer 24 is located on the bottom of the reaction chamber 19 and is away from the channel 23 to make the analyte solution on the bottom of the reaction chamber 19 enter an immobilized state quickly, so as to reduce the detecting time of the test strip 10 and improve the detecting accuracy of the test strip 10. Furthermore, since the cross sectional area of the reaction chamber 19 is several times greater than the channel 23, the flowing amount per unit time of the analyte solution could be reduced quite substantially when the analyte solution enters the channel 23 having a relatively smaller cross sectional area from the reaction chamber 19 having a relatively larger cross sectional area. Moreover, the flowing speed of the analyte solution could also be reduced greatly as the contact resistance between the analyte solution and the wall of the channel 23 increases, so as to immobilize the analyte solution for efficiently preventing the analyte solution from flowing over the channel 23.

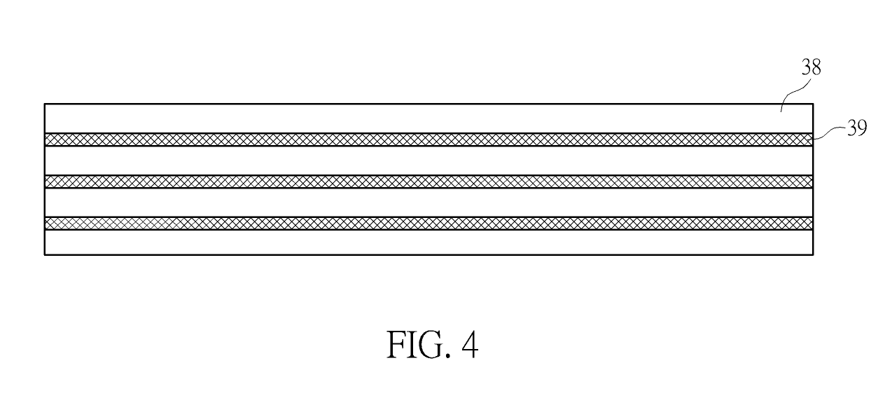

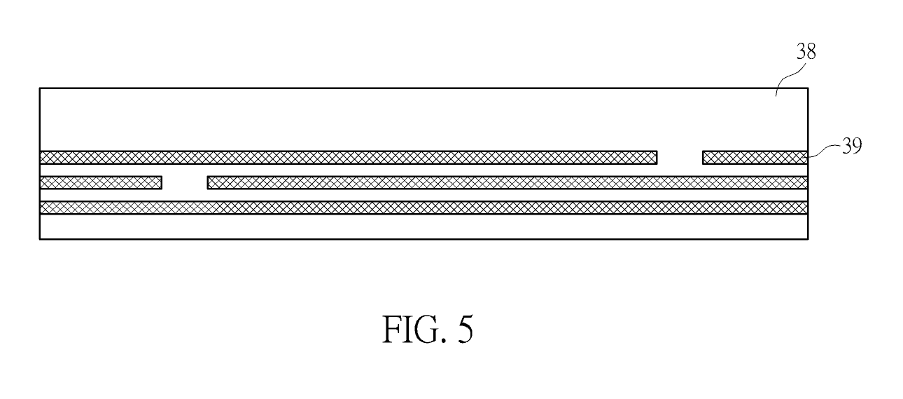

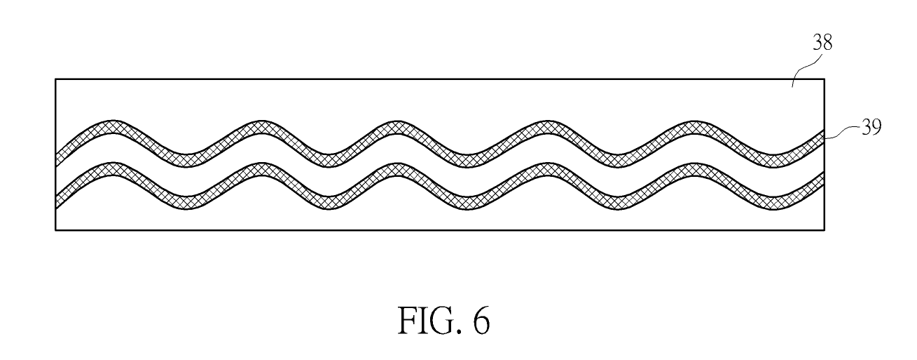

To be noted, in this embodiment, as shown in FIG. 3, a surface of the covering portion 36 corresponding to the reaction chamber 19 has at least one front end portion (close to an opening side of the reaction chamber 19) with a hydrophilic layer 37 coated thereon, or the hydrophilic layer 37 is coated over the surface of the covering portion 36 corresponding to the reaction chamber 19. At least one portion of a surface of the channel portion 38 corresponding to the channel 23 has a hydrophobic layer 39 coated thereon. For example, the hydrophobic layer 39 could be coated on the entire surface of the channel portion 38 as shown in FIG. 3, or could be coated alternately on the surface of the channel portion 38 in a continuous strip shape as shown in FIG. 4 (but not limited thereto, meaning that the hydrophobic layer 39 could also be coated on the surface of the channel portion 38 in a discontinuous strip shape as shown in FIG. 5 or in a wave shape as shown in FIG. 6). The contacting length of the hydrophobic layer 39 for the analyte solution depends on hydrophobicity of the hydrophobic layer 39 and viscosity of the analyte solution, and could be preferably between 200 μm and 1000 μm. In another embodiment, the hydrophilic layer 37 could also be coated over the bottom surface of the cover layer 16, and the hydrophobic layer 39 is coated on the surface of the channel portion 38. Moreover, in another embodiment, only the hydrophilic layer 37 needs to be coated on the covering portion 36 as the bottom surface of the cover layer 16 has hydrophobicity itself. That is to say, the present invention adopts the aforesaid designs for achieving the purpose that the surface of the covering portion 36 close to the opening side of the reaction chamber 19 has hydrophilicity and the channel portion 38 has hydrophobicity. As for whether the hydrophilic layer 37 and the hydrophobic layer 39 need to be coated on the cover layer 16 or not, it depends on the material of the cover layer 16.

In such a manner, via the coating design that the covering portion 36 has the hydrophilic layer 37 coated thereon and the channel portion 38 has the hydrophobic layer 39 coated thereon, the analyte solution could be absorbed by hydrophilicity of the hydrophilic layer 37 so as to enter and then fill the reaction chamber 19. Subsequently, the analyte solution could be repulsed by hydrophobicity of the hydrophobic layer 39 to be immobilized after the analyte solution contacts the hydrophobic layer 39 on the channel portion 38. On the other hand, if the excessive amount of the analyte solution enters the reaction chamber 19, the analyte solution would continue flowing along the channel 23. During the analyte solution flows from the reaction chamber 19 through the channel 23, as shown in FIG. 3, the hydrophobicity of the hydrophobic layer 39 could transform the shape of flowing of the analyte solution from concave in the reaction chamber 19 to convex in the channel 23, so as to make the analyte solution immobilized for efficiently preventing the analyte solution from flowing over the channel 23. In practical application, coating of the hydrophobic layer 39 is not limited to the aforesaid embodiment, meaning that the hydrophobic layer 39 could be selectively coated on at least one of the channel portion 38 of the cover layer 16 and the spacer layer 12. For example, the hydrophobic layer 39 could be coated on the entire surface of the spacer layer 12 or could be coated alternately on the surface of the spacer layer 12 in a continuous strip shape (but not limited thereto, meaning that the hydrophobic layer 39 could also be coated on the surface of the spacer layer 12 in a discontinuous strip shape or in a wave shape). As for which coating design is utilized, it depends on the practical application of the test strip 10.

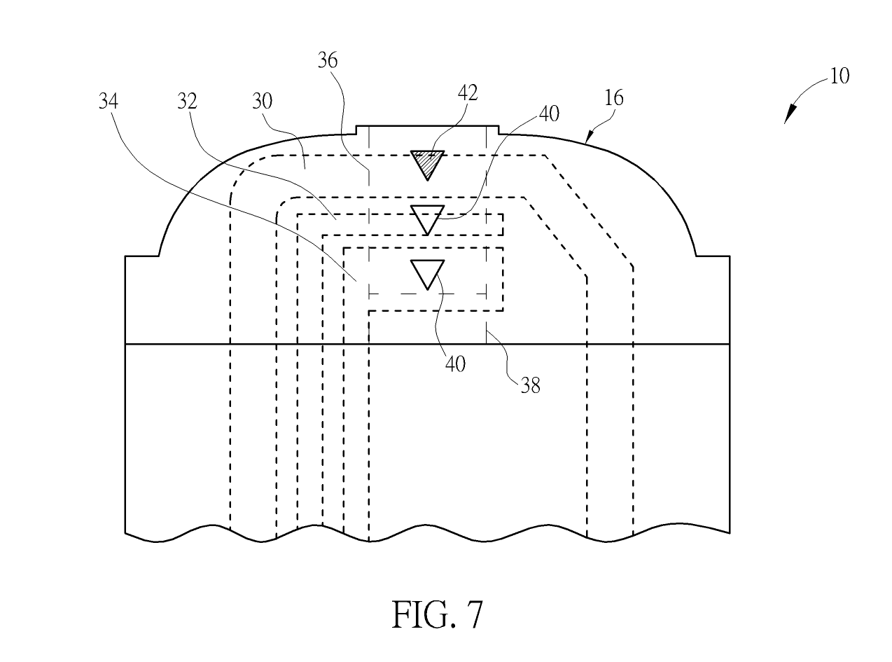

The hydrophobic layer 39 may also have its translucent/opaque characteristics and therefore it can also be used for covering the electrode portion of the covering portion 36 within one painting procedure to prevent light from being incident into the working electrode 30 via a transparent cover layer 16 as shown in FIG. 7, and then the hydrophilic layer 37 could be coated on the covering portion 36.

Furthermore, please refer to FIG. 7, which is a partial top view of the test strip 10 in FIG. 1. As shown in FIG. 7, the covering portion 36 could have at least one transparent window 40 for a user to see the analyte solution. The transparent window 40 could be formed on the covering portion 36 not corresponding to the working electrode 30. For example, the transparent window 40 could be aligned with a reference electrode 32 or be aligned with a gap between the reference electrode 32 and the auxiliary electrode 34. In this embodiment, the transparent windows 40 could be in a triangle shape (but not limited thereto, meaning that the transparent window 40 could be in a rectangle shape, a trapezoid shape, a polygon shape, an arrow shape, or a circular shape), and could be aligned with the reference electrode and the auxiliary electrode 34 respectively. In practical application, the covering portion 36 could further have an opaque mark 42 aligned with the working electrode 30. The transparent window 40 and the opaque mark 42 could be formed on the covering portion 36 by a conventional pattern forming process. For example, opaque paint could be first printed on the cover layer 16 made of transparent material and then a transparent pattern could be formed on the cover layer 16 to form the transparent window 40. Via the design that the transparent window 40 is formed on the cover layer 16 not corresponding to the working electrode 30, the test strip 10 not only allows the user to know the filling condition of the analyte solution and whether the test strip 10 has been used or not, but also prevents light from being incident into the working electrode 30 through the transparent window 40 so as to efficiently solve the reagent inactivation problem of the reagent layer when the reagent layer is excited by the external light and has been reacted by the external light before performing a test. Accordingly, the detecting accuracy of the test strip 10 could be improved. To be noted, where the transparent window 40 and the opaque mark 42 are formed is not limited to the aforesaid embodiment. For example, in another embodiment, the transparent window 40 could be only aligned with the auxiliary electrode 34 and the opaque marks 42 could be aligned with the working electrode 30 and the reference electrode 32 respectively. As for which design is utilized, it depends on the practical application of the test strip 10.

Via the aforesaid design, as shown in FIG. 3, when an analyte solution 44 is absorbed into the reaction chamber 19 quickly via the capillary phenomenon and the hydrophilicity of the hydrophilic layer 37, air originally staying in the reaction chamber 19 could be exhausted rearward via the channel 23 to ensure that the analyte solution 44 could enter the reaction chamber 19 smoothly. Accordingly, the present invention could solve the prior art problem that the analyte solution stops flowing inwardly due to air staying in the reaction chamber 19, so as to improve the detecting accuracy of the test strip 10. Furthermore, compared with the prior art adopting the upward (or downward) exhausting design that a hole (or a slit) is formed on a cover layer or a substrate, the present invention adopts the design that air originally staying in the reaction chamber could be exhausted rearward through the channel cooperatively formed by the spacer layer, the channel portion of the cover layer and the support layer, to efficiently solve the prior art problem that dust (or moisture) enters the reaction chamber via the hole (or the slit) easily.

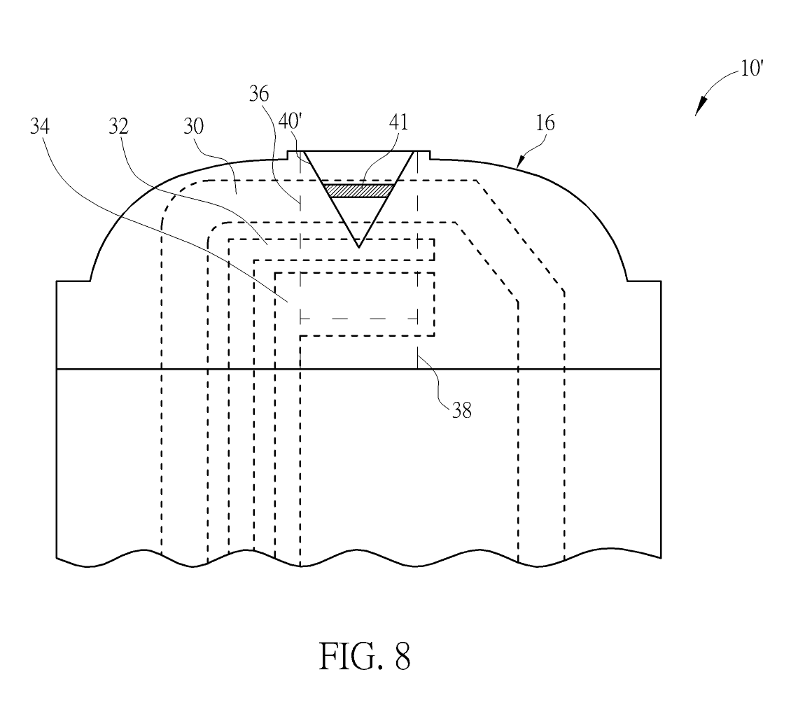

It should be mentioned that the design of the transparent window is not limited to the aforesaid embodiment. Please refer to FIG. 8, which is a partial top view of a test strip 10′ according to another embodiment of the present invention. Components both mentioned in FIG. 8 and the aforesaid embodiments represent components with similar functions or structures, and the related description is omitted herein. As shown in FIG. 8, the covering portion 36 of the cover layer 16 of the test strip 10′ has a transparent window 40′. The transparent window 40′ extends rearward from the front end of the cover layer 16 corresponding to an opening side of the reaction chamber 19 to cross the working electrode 30 and has a covering pattern 41. The covering pattern 41 is transversely disposed in the transparent window 40′ for partially covering the working electrode 30. The covering pattern 41 could be a straight line pattern as shown in FIG. 8, but not limited thereto, meaning that the covering pattern 41 could also be other pattern (e.g. an arc-shaped pattern or a wave-shaped pattern) for partially covering the working electrode 30. Accordingly, the test strip 10′ not only allows the user to know the filling condition of the analyte solution and whether the test strip 10 has been used or not via the transparent window 40′, but also properly reduces influence of light incident into the test strip 10′ via the transparent window 40′ since the covering pattern 41 could partially cover the working electrode 30, so as to improve the aforesaid reagent inactivation problem of the reagent layer for increasing the detecting accuracy of the test strip 10′.

Furthermore, the test strip of the present invention could only adopt the design that air originally staying in the reaction chamber could be exhausted rearward through the channel formed by the support layer, the channel portion of the cover layer and the spacer layer, or could only adopt the design that the transparent window is not aligned with the working electrode or the transparent window has the covering pattern partially covering the working electrode, so as to simplify the structural design of the test strip and improve flexibility of the structural design of the test strip. For example, in another embodiment, the test strip of the present invention could only adopt the design that the transparent window is not aligned with the working electrode, and could selectively adopt a conventional exhausting design, such as the upward (or downward) exhausting design that a hole (or a slit) is formed on the cover layer or the substrate. In another embodiment, the present invention could only adopt the design that air originally staying in the reaction chamber could be exhausted rearward through the channel formed by the support layer, the channel portion of the cover layer and the spacer layer, and could utilize other detecting method (e.g. a colorimetry method) to detect the analyte solution. As for the related description for other derived embodiments, it could be reasoned by analogy according to the aforesaid embodiments and omitted herein.

In summary, compared with the prior art adopting the upward (or downward) exhausting design that a hole (or a slit) is formed on the cover layer or the substrate, the present invention adopts the design that air originally staying in the reaction chamber could be exhausted rearward through the channel formed by the support layer, the channel portion of the cover layer, and the spacer layer, so as to efficiently solve the prior art problem that dust (or moisture) enters the reaction chamber via the hole (or the slit). Furthermore, via the design that the transparent window is not aligned with the working electrode, the test strip of the present invention not only allows the user to directly know the filling condition of the analyte solution and whether the test strip has been used or not, but also prevents light from being incident into the working electrode through the transparent window so as to efficiently solve the reagent inactivation problem of the reagent layer. Moreover, since the test strip of the present invention does not need to utilize additional electrodes to detect the filling condition of the analyte solution and whether the test strip has been used or not, the present invention could also solve the prior art problem that the additional electrical sensing circuit design prolongs the detecting process and increases the complexity and the power consumption of the electrical sensing strip.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A test strip comprising:
a spacer layer having a notch;
a substrate attached under the spacer layer, the substrate having a reaction region exposed from the notch;
a reagent layer coated on the reaction region;
a cover layer having a covering portion and a channel portion, the covering portion covering the notch, the channel portion extending rearward from the covering portion corresponding to a rear end of the notch; and
a support layer attached on the spacer layer and located at two sides of the notch, the support layer being connected to the cover layer and the spacer layer to make the channel portion away from the spacer layer at a vertical distance for forming a reaction chamber cooperatively with the covering portion, the notch, and the substrate, the reaction chamber allowing an analyte solution to enter and then react with the reagent layer, the support layer being further used for forming a channel cooperatively with the channel portion and the spacer layer, the channel allowing exhausting air in the reaction chamber, and at least one portion on a surface of at least one of the channel portion and the spacer layer corresponding to the channel having hydrophobicity.

2. The test strip of claim 1, wherein at least one front end portion on a surface of the covering portion corresponding to the reaction chamber has hydrophilicity.

3. The test strip of claim 2, wherein the hydrophilicity of the at least one front end portion on the surface of the covering portion corresponding to the reaction chamber is coating a hydrophilic layer.

4. The test strip of claim 1, wherein hydrophobicity of the at least one portion on the surface of the at least one of the channel portion and the spacer layer corresponding to the channel is coating a hydrophobic layer.

5. The test strip of claim 4, wherein the hydrophobic layer is made of translucent paint material.

6. The test strip of claim 1, wherein the spacer layer, the substrate, and the cover layer are made of insulation material, and the test strip further comprises:
an electrode layer disposed between the substrate and the spacer layer, the electrode layer contacting the reagent layer for detecting an electric reaction of the analyte solution reacting with the reagent layer, the electrode layer comprising a working electrode and an auxiliary electrode, the working electrode being used for detecting a current electrical response when the analyte solution reacts with the reagent layer to detect the electrical reaction of the analyte solution, and the auxiliary electrode being used for receiving a floating voltage to satisfy a voltage generated by the working electrode when the analyte solution reacts with the reagent layer.

7. The test strip of claim 6, wherein at least one transparent window is formed on the covering portion not corresponding to the working electrode, or extends rearward from a front end of the cover layer corresponding to an opening side of the reaction chamber to cross the working electrode and has a covering pattern to partially cover the working electrode.

8. The test strip of claim 7, wherein the at least one transparent window is aligned with the auxiliary electrode or is not aligned with the working and the auxiliary electrode.

9. The test strip of claim 8, wherein at least one opaque mark is formed on the covering portion and is aligned with the working electrode.

10. The test strip of claim 1, wherein a thickness of the spacer layer is between 50 μm and 200 μm.

11. The test strip of claim 1, wherein a thickness of the support layer is between 10 μm and 50 μm.

12. The test strip of claim 1, wherein a length of the channel is greater than 200 μm.

13. The test strip of claim 1, wherein the support layer is made of adhesive material to stick the cover layer on the spacer layer.

14. A test strip comprising:
a spacer layer having a notch;
a substrate attached under the spacer layer, the substrate having a reaction region exposed from the notch;
a reagent layer coated on the reaction region;
an electrode layer disposed between the substrate and the spacer layer, the electrode layer contacting the reagent layer for detecting an electric reaction of the analyte solution reacting with the reagent layer, the electrode layer comprising at least one working electrode and an auxiliary electrode, the working electrode being used for detecting a current electrical response generated by the analyte solution reacting with the reagent layer, and the auxiliary electrode being used for receiving a floating voltage to satisfy a voltage generated by the working electrode when the analyte solution reacts with the reagent layer; and
a cover layer having at least one transparent window formed thereon and covering the notch for forming a reaction chamber cooperatively with the notch and the substrate, the reaction chamber allowing the analyte solution to enter and then react with the reagent layer, and the at least one transparent window being formed on the cover layer not corresponding to the working electrode or extending rearward from a front end of the cover layer corresponding to an opening side of the reaction chamber to cross the working electrode and having a covering pattern to partially cover the working electrode.

15. The test strip of claim 14, wherein the at least one transparent window is aligned with the auxiliary electrode, or is not aligned with the working electrode and the auxiliary electrode.

16. The test strip of claim 15, wherein the cover layer further has at least one opaque mark, and the at least one opaque mark is aligned with the working electrode.

17. The test strip of claim 14, wherein the cover layer further has a covering portion and a channel portion, the covering portion covers the notch, the channel portion extends rearward from the covering portion corresponding to a rear end of the notch, the test strip further comprises a support layer attached on the spacer layer and located at two sides of the notch, the support layer is connected to the cover layer and the spacer layer to make the channel portion away from the spacer layer at a vertical distance for forming a reaction chamber cooperatively with the covering portion, the notch, and the substrate, the reaction chamber allows an analyte solution to enter and then react with the reagent layer, the support layer is further used for forming a channel cooperatively with the channel portion and the spacer layer, and the channel allows exhausting air in the reaction chamber.

18. The test strip of claim 17, wherein at least one front end portion on a surface of the covering portion corresponding to the reaction chamber has hydrophilicity, and at least one portion on a surface of at least one of the channel portion and the spacer layer corresponding to the channel has hydrophobicity.

19. The test strip of claim 18, wherein the hydrophilicity of the at least one front end portion on the surface of the covering portion corresponding to the reaction chamber is coating a hydrophilic layer, and the hydrophobicity of the at least one portion on the surface of the at least one of the channel portion and the spacer layer corresponding to the channel is coating a hydrophobic layer.

20. The test strip of claim 17, wherein the support layer is made of adhesive material to stick the cover layer on the spacer layer.
